(19) United States
(12) Patent Application Publication
(10) Pub. No.: US 2004/0111254 A1
(43) Pub. Date: Jun. 10, 2004

(54) User defined text NLS enablement

(75) Inventors: Edward D. Gogel, South San Francisco, CA (US); Michael Jen, Baldwin Place, NY (US); Larry K. Klosterboer, Round Rock, TX (US); Noah G. Sack, Sloatsburg, NY (US)

Correspondence Address: IBM Corporation, Intellectual Property Law, 2455 South Road, P386, Poughkeepsie, NY, 12601, US

(73) Assignee: INTERNATIONAL BUSINESS MACHINES CORPORATION, Armonk, NY

(21) Appl. No.: 10/313,504

(22) Filed: Dec. 5, 2002

(51) Int. Cl. G06F 17/20

(52) U.S. Cl. 704/8

(57) ABSTRACT

A system, method and program product for storing relational tables wherein the tables comprises alternative messages according to a variant such as a national language. The relational tables further comprise at least a message key specifying a message and a variant key specifying a variant for selecting the appropriate message from the alternative messages. For example, the relational tables comprise language variant=1 for English and Variant=2 for French. An SQL query searches or sorts the list relational tables for entries appropriate for the language of interest. The relational table entries can be edited and new alternative messages are assigned a new message key according to a predetermined algorithm.

### FIELD OF THE INVENTION

The present invention is directed to the field of data processing, and more particularly to data processing systems which allow concurrent multi-lingual use.

### BACKGROUND OF THE INVENTION

The change from centralized, batch operation of data processing systems to distributed, interactive usage has resulted in more users being directly involved with these systems. When a data processing system is used in a country with multiple national languages or is accessed by user terminals located in different countries with different national languages, the system must accept commands and respond in the national language or languages of the users. In the past, support for national languages has been accomplished by placing all messages in a collection that can be replaced either completely such that all users of a given system will see messages in a selected national language, or on a user by user basis such that each user will see messages of one national language. The first approach fails to offer a solution for users in a country, such as Canada, where there is more than one national language or in a multinational network environment where a company or organization my have computer users in many nations having many languages.

Furthermore, each language application may have unique attributes that must be conveyed to the system. For instance, a language may not have voice recognition capability installed.

It is also desirable to support pseudo language differences. For example, it may be desirable to phrase a computer error message directed to an unskilled operator “Call Service at 800 555-5555” but to a system programmer “Error Msg 6sg7”. Similarly, it may be desirable to provide message restriction or special language to departments within an organization or to different companies sharing the same system.

U.S. Pat. No. 6,327,593 “Automated System and Method for Capturing and Managing User Knowledge within a Search System” to Goiffon and assigned to Unisys describes a system and method is provided for allowing users to interactively modify a search index used in performing concept-based searches. The system includes a repository for storing a network of natural language concepts. The repository further stores associations between selected ones of the natural language concepts and other data items that are cataloged according to the natural language concepts, wherein the data items may be stored within the repository, or on one or more remote systems. A user provides one or more natural language concepts as a search query used to locate associated ones of the data items. Subsequent iterations of a search may be performed to modify the scope of the search. After successful search results are obtained, the user may create one or more new associations, wherein each association relates any of the one or more natural language concepts included within a query with any selected one of the data items located during any iteration of the search. Similarly, the user may delete selected associations existing between located ones of the natural language concepts and selected ones of the data items. This modification of the knowledge base allows the search index to evolve to reflect the needs of the user.

U.S. Pat. No. 4,615,002 to Innes and assigned to IBM “Concurrent Multi-lingual use in Data Processing System” provides an index in a table of messages to select the massage appropriate for a predetermined language.

### SUMMARY OF THE INVENTION

The present invention provides a novel relational database implemented in a relational database environment such as DB2 (available from IBM) that utilizes powerful SQL Query programs (available from IBM) to enable an application program to extract variant messages according to a preferred variant. In an embodiment, the database is used to provide a message table with multiple keys associated with each message therein. For example, the message table comprises a Language ID Key column, a Message ID Key column and a Message column. An application program needs to retrieve a message. The Message ID Key is known by the application program (for example, it may be a field in an HTML file for a web Browser display). The application program also knows the Language ID Key of the present user. This may be supplied to the application in a variety of ways including a straight forward query to the user translated into an ID by a lookup table technique. The application program performs a query (preferably a DB2 SQL query) to find the message that corresponds to the Message ID Key and the Language ID key.

In optional embodiments, the Message Table system comprises multiple tables that are linked by a relational database means such as DB2. For example the Message Table may be linked to a Language Table by a many-to-one link of the Language ID Key of each table.

In one embodiment, messages are entered into the Message table by supplying the Language ID Key and Message Text along with a new Message ID Key where the new message ID Key is automatically generated according to a predetermined algorithm such as a next sequential number generator. In the embodiment, the same new message ID key is used for each language variant of the message text entered and only the Language ID Key and Message text are different.

It is therefore an object of the present invention to provide a message translation service comprising a Message Table comprising a Language ID Key, a Message ID Key and a Message Text.

It is another object of the invention to supplement the Message Table with additional tables wherein the additional tables and Message Table comprise a relational database.

It is another object of the invention to search or sort the tables using SQL queries.

It is another object of the invention to automatically generate Message ID Keys according to a predetermined algorithm.

It is another object of the invention to access a desired version of a message in the message table using a Language ID Key and a Message ID Key.

It is another object of the invention to provide a language ID that represents any one of a national language, a pseudo language, a regional language, an organization language or a skill level language.

It is another object of the invention to translate the message obtained to any one of a text display, an audio message, a video message, a network message or a mechanical operation.

### BRIEF DESCRIPTION OF THE DRAWINGS

These and other objects will be apparent to one skilled in the art from the following detailed description of the invention taken in conjunction with the accompanying drawings in which:

FIG. 1 depicts an example computer system;

FIG. 2 depicts an example computer network system;

FIG. 3 depicts an example Message Table according to the present invention;

FIG. 4 depicts a Relational Database system according to the present invention;

FIG. 5 depicts an alternate Relational Database system according to the present invention;

FIG. 6 depicts example tables of the present invention;

FIG. 7 depicts example tables of the present invention;

FIG. 8 depicts operation of the present invention; and

FIG. 9 depicts operation of the present invention.

### DESCRIPTION OF THE PREFERRED EMBODIMENT

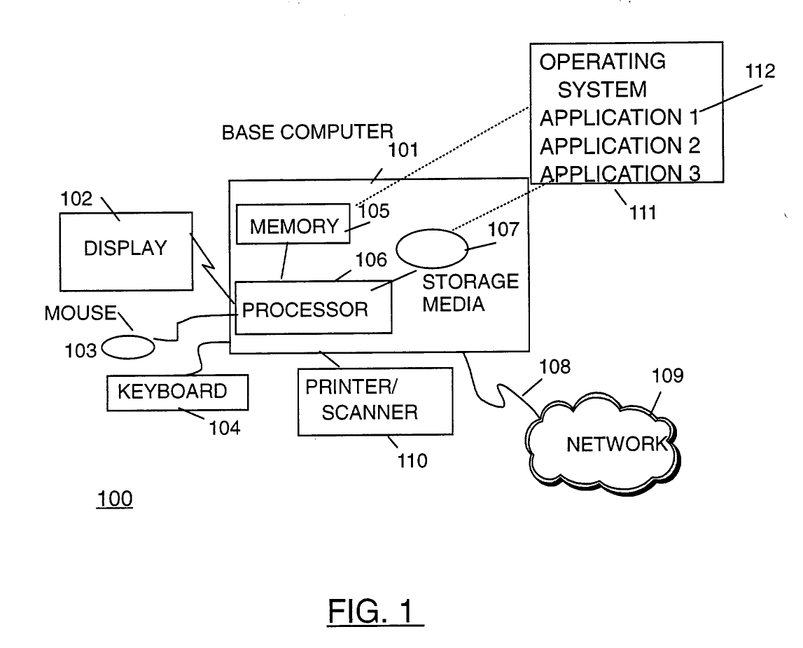

FIG. 1 illustrates a representative workstation hardware system in which the present invention may be practiced. The system 100 of FIG. 1 comprises a representative single user computer workstation 101, such as a personal computer, including related peripheral devices. The workstation 101 includes a microprocessor 106 and a bus employed to connect and enable communication between the microprocessor 106 and the components of the workstation 101 in accordance with known techniques. The workstation 101 typically includes a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter. The bus also connects the microprocessor 106 to memory 105 and long-term storage 107 which can include a hard drive, diskette drive, tape drive, etc.

The workstation 101 may communicate with other computers or networks of computers by way of a network adapter capable of communicating with a network 109. Example network adapters are communications channels, token ring, ethernet or modems. Alternatively, the workstation 101 may communicate using a wireless interface, such as a CDPD (cellular digital packet data) card. The workstation 101 may be associated with such other computers in a local area network (LAN) or a wide area network (WAN), or the workstation 101 can be a client in a client/server arrangement with another computer, etc. All of these configurations, as well as the appropriate communications hardware and software, are known in the art.

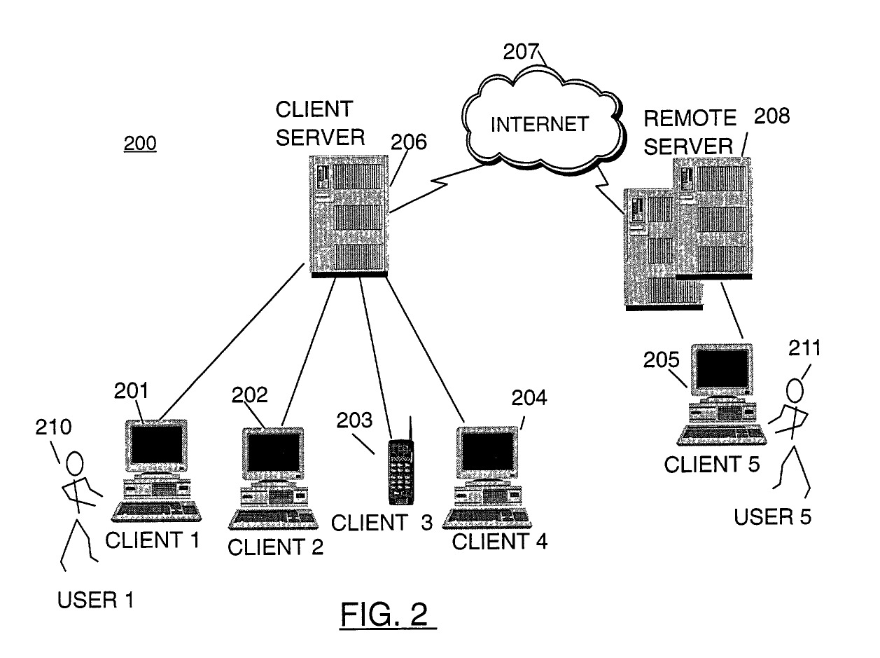

FIG. 2 illustrates a data processing network 200 in which the present invention may be practiced. The data processing network 200 may include a plurality of individual networks, such as wireless network and a wire network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zSeries 900 machine available from IBM. (IBM and zSeries are trademarks of IBM).

The gateway computer 206 may also be coupled to a storage device (such as data repository). Further, the gateway 206 may be directly or indirectly coupled to one or more workstations 101 such as clients 1-4 201-204 as shown.

Those skilled in the art will appreciate that the gateway computer 206 may be located a great geographic distance from the network, and similarly, the workstations 101 may be located a substantial distance from the networks. For example, the network may be located in California, while the gateway 206 may be located in Texas, and one or more of the workstations 101 may be located in New York. The workstations 101 may connect to the wireless network using a networking protocol such as the Transmission Control Protocol/Internet Protocol (“TCP/IP”) over a number of alternative connection media, such as cellular phone 203, radio frequency networks, satellite networks, etc. The wireless network preferably connects to the gateway 206 using a network connection such as TCP or UDP (User Datagram Protocol) over IP, X.25, Frame Relay, ISDN (Integrated Services Digital Network), PSTN (Public Switched Telephone Network), etc. The workstations 201-204 may alternatively connect directly to the gateway 206 using dial connections. Further, the wireless network and wired network may connect to one or more other networks, in an analogous manner to that depicted in FIG. 2.

Software programming code which embodies the present invention is typically accessed by the microprocessor 106 of the workstation 101 (clients 1-5 201-205) or server 206 from long-term storage media 107, such as a CD-ROM drive or hard drive. The software programming code comprising the present invention may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the microprocessor 106 using the processor bus. Such programming code includes an operating system which controls the function and interaction of the various computer components and one or more application programs. One application program 112 may be the application of the present invention. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

A user of the present invention may connect his computer to a server using a wireline connection, or a wireless connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing and communication capabilities. The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

In the preferred embodiment, the present invention is implemented as one or more computer software programs 111. The implementation of the software of the present invention may operate on a user's workstation, as one or more modules or applications 111 (also referred to as code subroutines, or “objects” in object-oriented programming) which are invoked upon request. Alternatively, the software may operate on a server in a network, or in any device capable of executing the program code implementing the present invention. The logic implementing this invention may be integrated within the code of an application program 112, or it may be implemented as one or more separate utility modules which are invoked by that application 112, without deviating from the inventive concepts disclosed herein. The application 112 may be executing in a Web environment, where a Web server provides services in response to requests from a client connected through the Internet. Application 1 (112) in one embodiment comprises the present invention. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

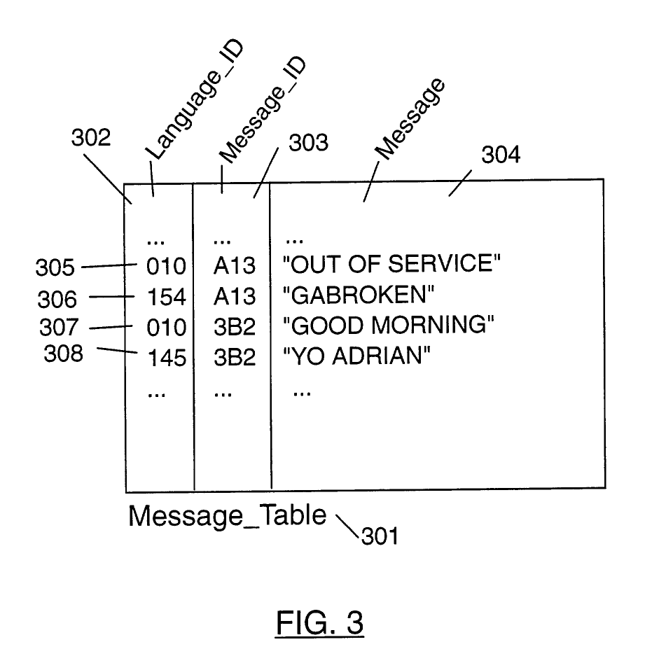

The present invention provides a message table with multiple keys associated with each message therein. For example, referring to FIG. 3, the message table comprises one or more “Variant” ID key's exemplified herein by a Language ID Key column 302, one or more Message ID Keys column 303 and a Message text column 304. Other arrangements are possible including having a pointer in the message 304 column to the location of the actual message in another table. The invention is not limited to having text messages, other embodiments would support messages that provided audio, video, program language or other computer readable format files well known in the art. When the application program needs to retrieve a message text, it preferably uses an SQL query. The Message ID Key is known by the application program (for example, it may be a field in an HTML file for a web Browser display). The application program also knows the Language ID Key of the present user. This may be supplied to the application in a variety of ways including a straight forward query to the user translated into an ID by a lookup table technique. The application program performs a query (such as a DB2 SQL query) to find the message that corresponds to the Message ID Key and the Language ID key. Example records 305-308 demonstrate the functionality of the table. In Record 305, an American language_ID key of “010” is associated with a Message_ID key of A13 which specifies “OUT OF SERVICE”. Thus when an application program wants to present the message of Message_ID A13, it queries the table with the Message_ID code “A13” and Language ID “010”. In another environment, the same message is required. Once again the application program queries the message table 301 with message_ID “A13” but this time the language_ID key of the user is “154” which represents Message text 304 “GABROKEN”. Thus, the application is able to retrieve a message from the table in the language of its choice.

In another example, record 307 contains the message “GOOD MORNING” according to Message_ID key 3B2 in a language used by American hotel chain customers (Language_ID 010). However, a pseudo language for Boxers from South Philadelphia (having a Language_ID key of 145) provides

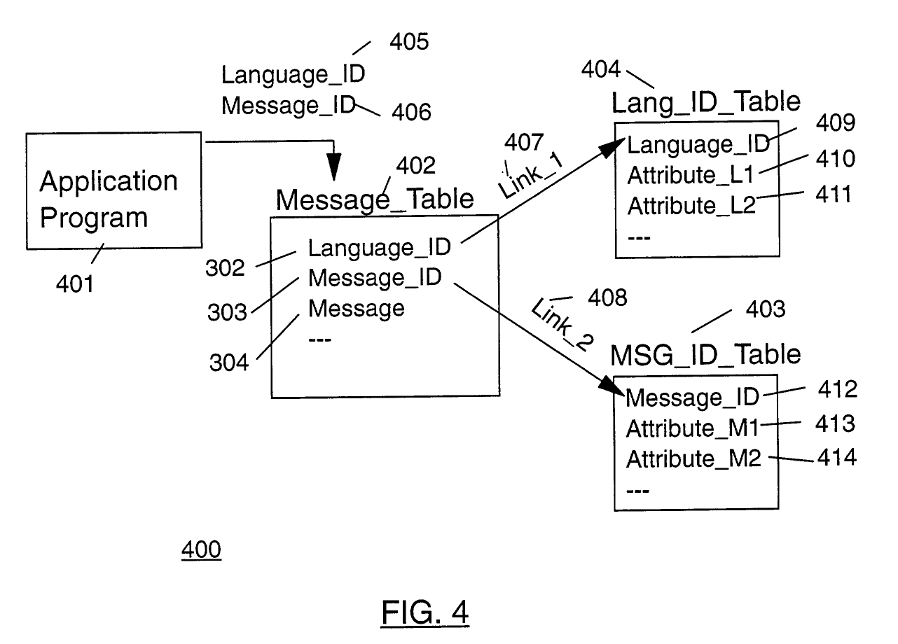

In an embodiment, FIG. 4, the Message Table system 400 comprises multiple tables 402-404 that are linked by a relational database means such as DB2. For example the Message Table 402 may be linked to a Language Table 404 by a many-to-one link (Link 1 407) of the Language ID Key 302 409 of each table 402 404. Similarly, the Message_Table 402 may be linked to a MSG_ID Table 403 by a many-to-one link (Link 2 408) of the Message ID Key 303 412 of each table 402 403. An application program 401 provides Language_ID keys 405 and Message_ID keys 406 for use in querying the system 402-404.

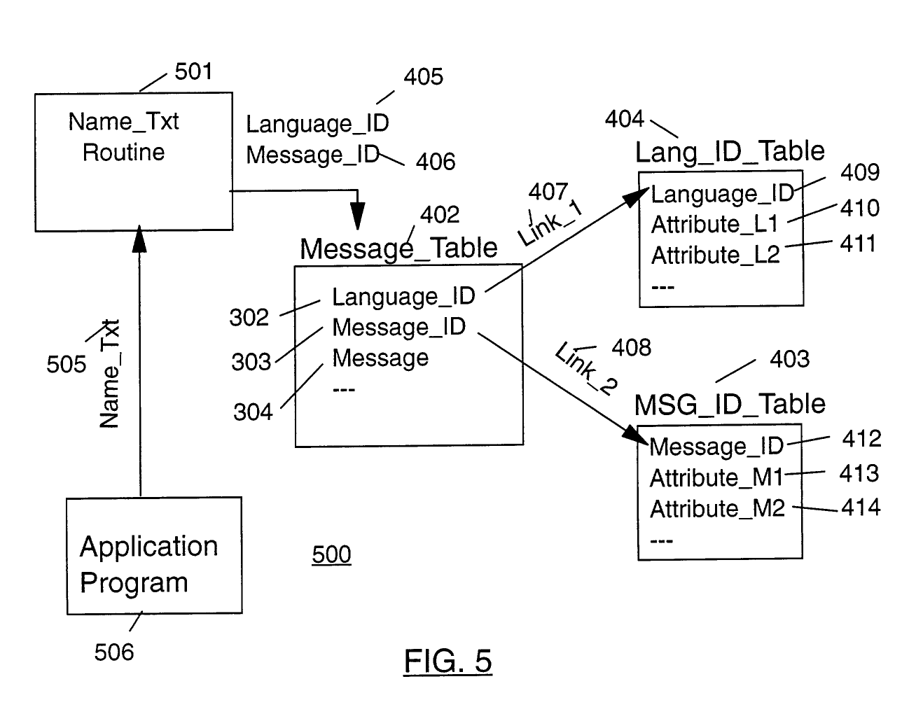

In another embodiment FIG. 5, the system of FIG. 4 402-4-4 comprises an additional Name_Txt routine 501 which translates the application program's 506 request (Name_Txt 505) into the appropriate Message_ID 406.

In one embodiment, messages are entered into the Message table by supplying the Language ID Key and Message Text along with a new Message ID Key where the new message ID Key is automatically generated according to a predetermined algorithm such as a next sequential number generator. In the embodiment, the same new message ID key is used for each language entered and only the Language ID Key and Message text are new. Thus, an authorized agent can edit (Add, Delete, Modify) message text that is shared by a multiplicity of users.

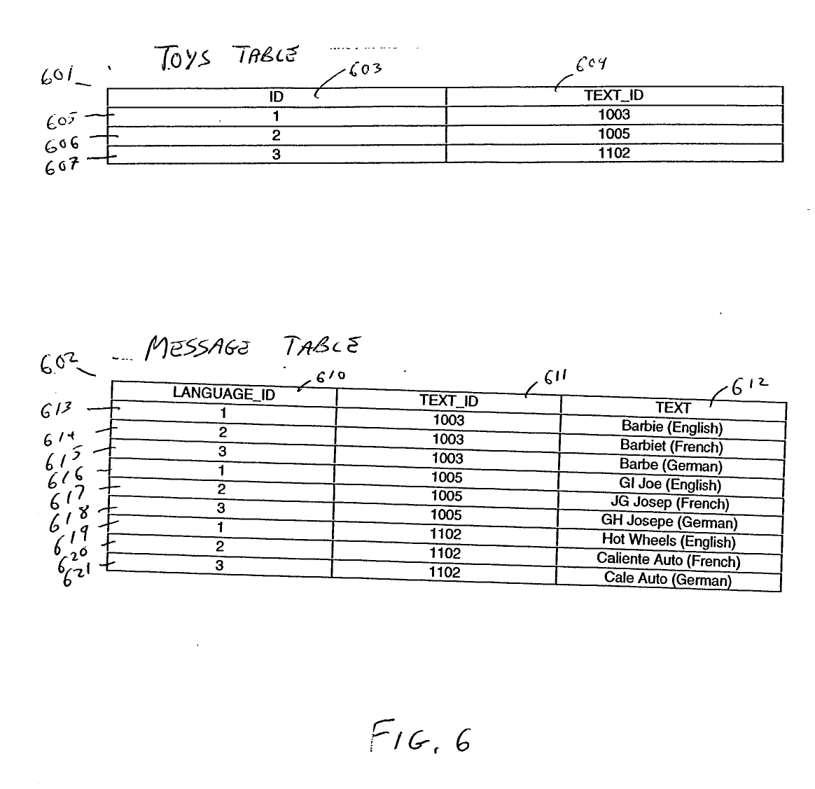

In another DB2 embodiment, a message_table 402 is “joined” to a “Toys” table 601 comprising hundreds of entries. Referring to FIG. 6, the entries of the “Toys” table 601 would include an ID code column 603 and a TEXT_ID column 604. In the example, one record 605 describes a toy with an ID of 1 that has a TEXT_ID of 1003. For each entry in the “Toys” table 601, there is exactly one entry in the message table 602 per language variant. Of course a National language variant is only one example of a variant, other variants may be useful such as a customer ID and such variants can be combined in a pseudo variant or separately listed in columns in the message table 402.

Still referring to FIG. 6, the message table 602 comprises a Language_ID key column 610, a TEXT_ID message key column 611, and a TEXT message column 612. In one record 613, language_ID=1 (English) variant key in column 610 is related to TEXT_ID=1003 message ID key column 611 and TXT message text column 612. In record 614, the same TEXT_ID=1003 is used in column 611 but a different Language_ID=2 column 610 associated with a French version of the TEXT message text field in column 612.

Using standard SQL programming, these tables are joined so they can be searched or sorted according to the needs of the Application program 506. For example, the following SQL phrases are used to query the database:

SELECT ID, TEXT FROM TOYS, MESSAGE

WHERE TOYS.TEXT_ID=MESSAGE.TEXT_ID

AND MESSAGE.LANGUAGE_ID=1

ORDER BY ASCENDING TEXT

The example query “WHERE TOYS.TEXT_ID=MESSAGE.TEXT_ID” above asks to take each TEXT_ID 604 entry in TOYS table 601 and join it with the corresponding TEXT_ID entry 611 in the Message table 602 match and output the ID 603 and TEXT 612 for the English version (Language_ID=1) and sort the resulting list of toys in TEXT 612 (ORDER) by the TEXT 612 field. If the Language_ID=2 (French), the sort order may result in a different order than the English result list.

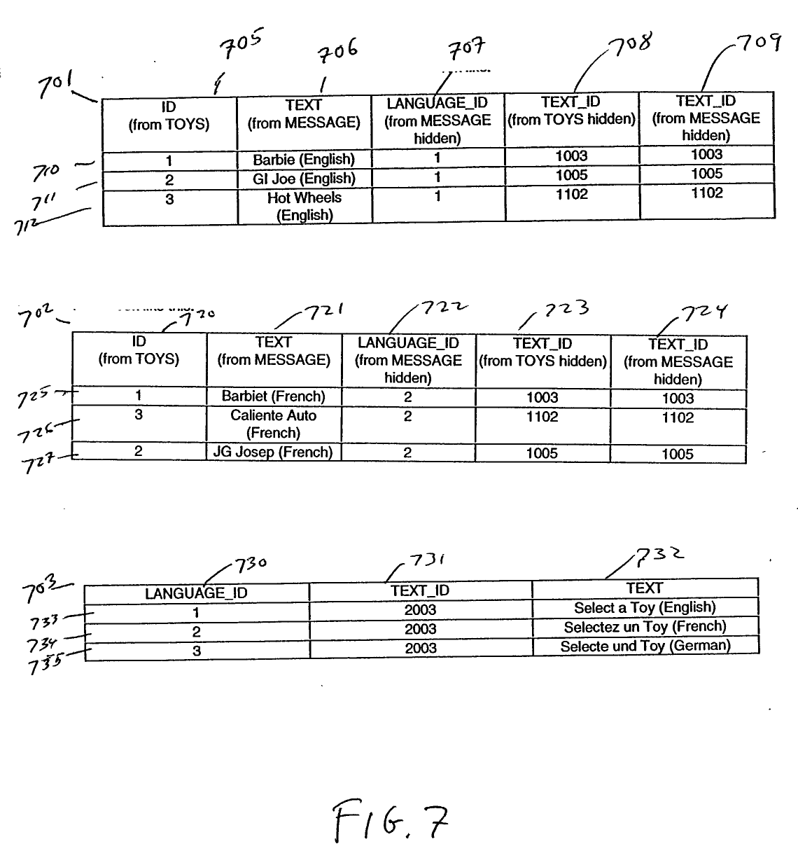

FIG. 7 is an example of the SQL “Temporary Table” 701 of linked attributes would look like for the English query. The ID column 705 lists the IDs of the toys, the TEXT column 706 lists the corresponding English text for each toy, Language_ID column 707 lists the Language_ID value (1), the TEXT_ID column from the TOYS table 708 and from the Message Table 709 lists the TEXT_ID for each toy.

The temporary table 702 for the French query shows the same results except the message text 721 is French, the Language_ID=2 723 for French and the sort order is different from the English temporary table 701.

A variation on the SQL program performs a search:

SELECT ID, TEXT FROM TOYS, MESSAGE

WHERE TOYS.TEXT_ID=MESSAGE.TEXT_ID

AND MESSAGE.LANGUAGE_ID=2

AND TEXT LIKE ‘%CAL%’

ORDER BY ASCENDING TEXT

This query asks to do the same thing as the sorting query but only include those entries in TOYS where the description of the toy (found in the TEXT column 721) contains the characters ‘CAL’. The same type of “Temporary file” table is created 702 but it only contains the entries which match this search condition 726. That is, there would only be one row in French 626 but no rows in English.

In this way, the application can search and sort and once the user selects what they want, the ID in the TOYS table 601 which would represent a product number for instance, could be added to the user's order for use by the department shipping the toy to the customer.

Additionally, given the MESSAGE table 602 by itself, there can be regular application messages stored in the multiple languages and referred to by the programs which display the messages only by number (TEXT_ID). Given the example above, there would have to be text which tells the customer to “Select the Toy you wish to purchase from the following list:” appended before the list.

In this case, a generic program takes Language_ID and TEXT_ID as input and returns the TEXT as output. This program is called dynamically as the panel or web page is being built for display to the end user and populate the panel with the correct language version(s) of the text.

The message table contains the information exemplified in FIG. 7 703. Then, as a web page is being built for display by a browser, the program building the web page calls the generic message program giving Language_ID=2 and TEXT_ID=2003 which would enable the program to display the French text 734 received from the query asking the customer to select a toy.

By implementing User Defined Text NLS Enablement, this invention provides a process which uses a number index for each piece of text which could potentially be seen or entered or changed by an end user and a language identifier along with this index is the key to the text data source. Additionally, by allowing all text to be translated by the end user and placed into the data source, the invention provides the ability of custom and user entered text to be displayed in multiple languages within one installation of a program according to the invention. By using a relational data source for these text messages and joining the various other data sources to the text data source, the invention provides sorting and searching for each language independently of each other language.

Messages can be either system-defined or user-defined providing seamless and generic internationalization for all text that is sent or displayed through the user interface(s).

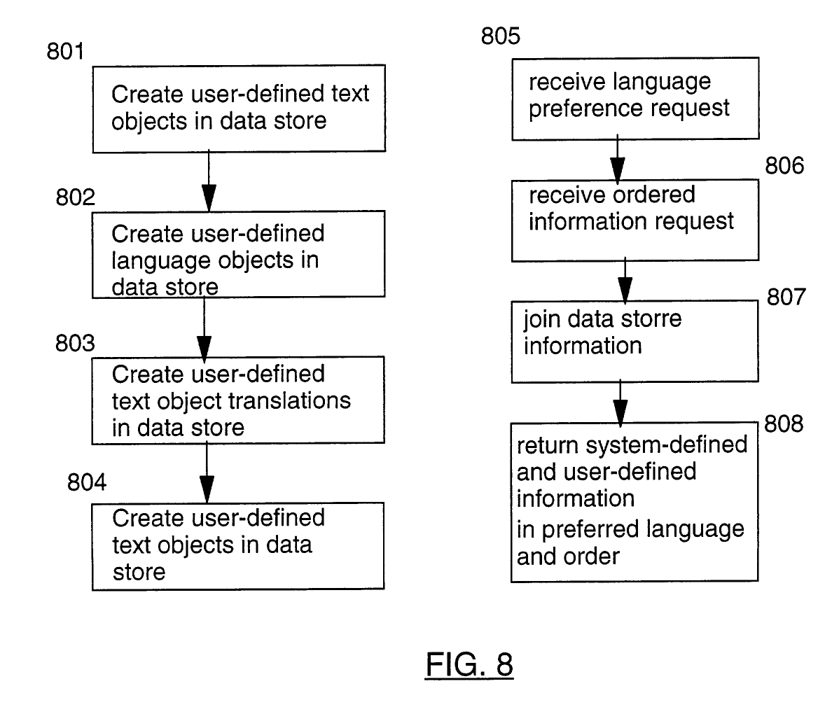

Referring to FIG. 8, the process of creating the database is portrayed. The user-defined Text message keys are stored in the database 801, user-defined variant keys including National Language identifiers are stored in the database 802, user-defined translations of the text messages are stored in the database according to their variant key 803.

When the database is queried, it receives a language preference variant key 805, it receives an ordered query request 806, it receives table join information if multiple tables are employed 807, and it returns message text information in a predetermined language 808.

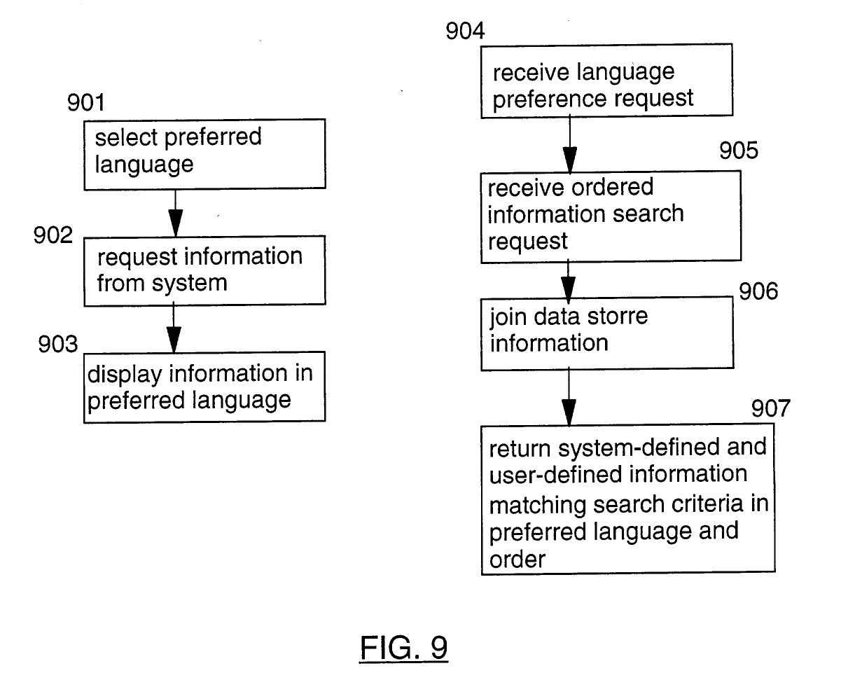

Referring to FIG. 9, the application program selects a preferred language key 901, performs a query 902, and displays the message in the preferred language 903.

The system receives the preferred language key 904, receives the query (preferably SQL) 905, receives relational database join information 906 and returns the message in the preferred language.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A system for providing a relational table having a plurality of message texts, said system comprising:
a memory for storing data;
a relational table stored in said memory, said relational table having:
one or more message text areas wherein a first message text area comprises a plurality of message texts, said message texts comprising a first message text and a second message text;
one or more message identification areas wherein a first message identification area comprises a plurality of message identifications, wherein a first message identification is related to both of said first message text and said second message text; and
one or more variant identification areas wherein a first variant identification area comprises a plurality of first variant identifications and second variant identifications, wherein said first variant identification is related to said first message text.

2. The system of claim 1 wherein the first message text is in a first national language and the second message text is in a second national language, and the first variant identification area is related to national languages and the first variant identification is related to said first national language.

3. The system of claim 1 wherein the first variant identification area is related to any one of company, department or skill level and the first variant identification is related to any one of a first company, a first department or a first skill level.

4. The system of claim 1 further comprising an application program for supplying a message identification and a variant identification to said relational table for receiving from said table a message text related to said message identification said variant identification.

5. The system of claim 4 further comprising a second relational table joined to the first relational table by any one of said message identification or said variant identification wherein said application program provides a search argument to said second relational table, which second relational table supplies said one of said message identification or said variant identification for said first relational table.

6. The system of claim 1 further comprising an insertion program for adding at least one message identifier, variant identifier and message text into said relational table.

7. The system of claim 1 wherein said memory includes a message receiving area for receiving messages from said relational table, and said system further comprising a sort program for sorting the messages in said message receiving area whereby messages are sorted in accordance with the variant identified by the variant identifications of said received messages.

8. The system of claim 1 wherein said memory includes a message receiving area for receiving messages from said relational table, and said system further comprises a search routine for searching the messages in said message receiving area whereby messages are searched in accordance with the variant identified by the variant identifications of said received messages.

9. A method for providing a relational table having a plurality of message texts, said method comprising the steps of:
storing a relational table in a memory;
storing in said table one or more message text areas wherein a first message text area comprises a plurality of message texts, said message texts comprising a first message text and a second message text;
storing in said table one or more message identification areas wherein a first message identification area comprises a plurality of message identifications, wherein a first message identification is related to both of said first message text and said second message text; and
storing in said table one or more variant identification areas wherein a first variant identification area comprises a plurality of first variant identifications and second variant identifications, wherein said first variant identification is related to said first message text.

10. The method of claim 9 wherein the first message text is in a first national language and the second message text is in a second national language, and the first variant identification area is related to national languages and the first variant identification is related to said first national language.

11. The method of claim 9 wherein the first variant identification area is related to any one of company, department or skill level and the first variant identification is related to any one of a first company, a first department or a first skill level.

12. The method of claim 9 further comprising the steps of:
supplying a message identification
supplying a variant identification to said relational table; and
receiving from said table a message text related to said message identification said variant identification.

13. The method of claim 12 further comprising the steps of:
joining a second relational table to the first relational table by any one of said message identification or said variant identification;
providing a search argument to said second relational table; and
supplying from said second relational table said one of said message identification or said variant identification for said first relational table.

14. The method of claim 9 further comprising the steps of:
an insertion program adding at least one message identifier, variant identifier and message text into said relational table.

15. The method of claim 9 further comprising the steps of:
receiving at said memory in a message receiving area, messages from said relational table; and
sorting the messages in said message receiving area whereby messages are sorted in accordance with the variant identified by the variant identifications of said received messages.

16. The method of claim 9 further comprising the steps of:
receiving at said memory in a message receiving area, messages from said relational table; and
searching the messages in said message receiving area whereby messages are searched in accordance with the variant identified by the variant identifications of said received messages.

17. A computer program product for providing a relational table having a plurality of message texts, said computer program product comprising a computer readable medium having computer readable program code therein comprising:
computer readable program code for storing a relational table in a memory;
computer readable program code for storing in said table one or more message text areas wherein a first message text area comprises a plurality of message texts, said message texts comprising a first message text and a second message text;
computer readable program code for storing in said table one or more message identification areas wherein a first message identification area comprises a plurality of message identifications, wherein a first message identification is related to both of said first message text and said second message text; and
computer readable program code for storing in said table one or more variant identification areas wherein a first variant identification area comprises a plurality of first variant identifications and second variant identifications, wherein said first variant identification is related to said first message text.

18. The computer program product of claim 17 wherein the first message text is in a first national language and the second message text is in a second national language, and the first variant identification area is related to national languages and the first variant identification is related to said first national language.

19. The computer program product of claim 17 wherein the first variant identification area is related to any one of company, department or skill level and the first variant identification is related to any one of a first company, a first department or a first skill level

20. The computer program product of claim 17 further comprising
computer readable program code for supplying a message identification
computer readable program code for supplying a variant identification to said relational table; and
computer readable program code for receiving from said table a message text related to said message identification said variant identification.
